(19) United States
(12) Patent Application Publication
(10) Pub. No.: US 2025/0064017 A1
(43) Pub. Date: Feb. 27, 2025

(54) SYSTEM AND METHOD FOR MONITORING ANIMAL ACTIVITY

(71) Applicant: Ceres Tag Ltd, Red Hill, Queensland (AU)

(72) Inventor: David Ian Smith, Red Hill (AU)

(73) Assignee: Ceres Tag Ltd, Red Hill, Queensland, QL (AU)

(21) Appl. No.: 18/726,093

(22) PCT Filed: Feb. 22, 2023
(86) PCT No.: PCT/AU2023/050124

§ 371 Date: Jul. 1, 2024

(30) Foreign Application Priority Data
Feb. 22, 2022 (AU) 2022900394

(51) Int. Cl. A01K 11/00; A01K 29/00

(52) U.S. Cl. CPC A01K 11/004; A01K 11/008; A01K 29/005

(57) ABSTRACT

A system for monitoring animal activity, the system comprising an animal tag having a tag identifier attached to an animal to generate animal data packets comprising timestamped location data having tag latitudinal and longitudinal coordinates and timestamped activity data relating to activity of the animal over a window of time and a processor configured to evaluate the animal data packets to determine an activity classification for the animal wearing the animal tag over the window of time. The processor is also configured to calculate a pasture performance value of the area based on the animal data packets received from the animal tag.

### TECHNICAL FIELD

The present invention relates to a system and method for monitoring animal activity and pasture performance in an area or paddock.

### BACKGROUND

Any references to methods, apparatus or documents of the prior art are not to be taken as constituting any evidence or admission that they formed, or form part of the common general knowledge.

Monitoring the health, location and activity of animals, both individually and in large groups, reliably and accurately is incredibly difficult without physically attending to each animal.

Livestock theft and fraud is a major issue and most incidents of livestock theft go unsolved.

Furthermore, monitoring the performance of a pasture or paddock that animals are located on to prevent overgrazing or to rectify deficiencies is also difficult.

### SUMMARY OF INVENTION

In an aspect, the invention provides a system for monitoring animal activity, the system comprising:
an animal tag having a tag identifier, the animal tag attached to an animal to generate animal data packets comprising timestamped location data having tag latitudinal and longitudinal coordinates, and timestamped activity data relating to activity of the animal over a window of time; and
a processor configured to evaluate the animal data packets to determine an activity classification for the animal wearing the animal tag over the window of time.

Preferably, the processor of the system for monitoring livestock in an area is further configured to generate an alert when the activity classification exceeds a threshold value or is outside of a threshold range.

Preferably, the activity classification includes behavioural data indicative of a behaviour of the animal at one or more points in time during the window of time or across the entire window of time.

Preferably, the behavioural data indicative of the behaviour of the animal at one or more points in time during the window of time or across the entire window of time is classified as one of: Walking; Resting; Grazing; Ruminating; Drinking; and Other (Unclassified). Preferably, the activity classification is a function of the activity data of the animal over the window of time.

Preferably, the animal tag generates timestamped location data having tag latitudinal and longitudinal coordinates and timestamped activity data relating to activity of the animal multiple times over the window of time. Preferably, the animal tag generates timestamped location data having tag latitudinal and longitudinal coordinates and timestamped activity data relating to activity of the animal at predetermined intervals over the window of time (e.g. every 10 milliseconds).

Preferably, evaluating the animal data packets to determine an activity classification for the animal wearing the animal tag over the window of time comprises determining a plurality of activity classifications for the animal wearing the animal tag, wherein each activity classification is associated with a sub-period of the window of time. Preferably, the window of time is divided into a plurality of sub-periods, wherein each sub-period comprises the same amount of time (e.g. the window of time is 4 hours and is divided into 4 sub-periods, each 1 hour long).

Preferably, the system further comprises an image of an area comprising one or more paddocks having area latitudinal and longitudinal coordinates and the processor is further configured to:
apply a tag overlay applicator so that each tag is graphically represented on the image of the area on a display at the corresponding latitudinal and longitudinal coordinates received from the animal data packets; and
allocate to each graphically represented tag:
   a label comprising the tag identifier;
   the location data; and
   activity data relating to the animal.

Preferably, the display comprises a user interface.

Preferably, the animal data packets further comprise a temperature of the animal tag.

Preferably, timestamped activity data relating to activity of the animal over a window of time is indicative of the activity of the animal over the window of time. Preferably, the timestamped activity data relating to activity of the animal over a window of time comprises a temperature of the animal and/or the animal tag and movement data relating to the movement of the animal.

Preferably, the processor is further configured to calculate a pasture performance value of a paddock or an area associated with the animal based on the animal data packets received from the animal tag. More preferably, the processor is further configured to calculate a pasture performance value of the paddock or the area based on the activity classification.

Preferably, the processor is further configured to calculate a pasture performance value of a paddock or an area associated with the animal based on the animal data packets received from the animal tag, wherein the paddock or the area associated with the animal is derived from the location data received from the animal tag. Preferably or alternatively, the paddock or the area associated with animal is derived from the location data received from the animal tag and/or geofence data associated with the animal tag.

Preferably, calculating the pasture performance value based on the animal data packets received from the animal tag comprises evaluating the animal data packets for each timestamp to determine an activity classification for the animal wearing the animal tag.

Preferably, the pasture performance value relates to a part of an area or paddock or a plurality of paddocks associated with the animal or that the animal is located in. Preferably, the pasture performance value is indicative of the performance of the pasture as a function of the activity classification.

Preferably, the system comprises a plurality of animal tags, each animal tag being attached to a unique animal to generate timestamped animal data packets comprising location data having tag latitudinal and longitudinal coordinates and activity data relating to activity of the animal.

Preferably, the system further comprises applying a trained machine learning model to animal data packets. Preferably, evaluating the animal data packets to determine an activity classification for the animal wearing the animal tag over the window of time comprises evaluating the animal data packets with a trained machine learning model to determine the activity classification and/or the pasture performance value.

Preferably, the location data further comprises location accuracy data.

Preferably, the animal tag comprises an accelerometer. Preferably, the accelerometer is configured to constantly record movement data and the processor arranges the movement data into n second packets.

Preferably, the activity classification further comprises pasture intake data. Preferably, the processor evaluates the animal data packets to determine the activity classification including pasture intake data including an estimate of pasture intake determined based on the behavioural data for the animal associated with the animal tag. Preferably, the estimate of pasture intake is determined based on behavioural data classified as Grazing.

Preferably, the processor is further configured to evaluate the pasture intake data to determine methane production data including estimates of methane production for the animal associated with the animal tag.

Preferably, the animal tag comprises memory configured to store animal data and the animal data packets. Preferably, the memory is configured to store the location data obtained from the GPS receiver, and at least one of a timestamp associated with a time of the location data and a unique identifier associated with the animal tag and/or the animal.

Preferably, the animal tag includes the processor. Preferably, the processor is an on-board processor of the animal tag. Preferably, the processor comprises a processing server, a processor and memory to store animal data and the animal data packets.

In another aspect, the invention provides a method for monitoring animal activity comprising:
evaluating animal data comprising a tag identifier for an animal tag attached to an animal to generate animal data packets comprising timestamped location data having tag latitudinal and longitudinal coordinates and timestamped activity data relating to activity of the animal over a window of time; and
determining an activity classification for the animal wearing the animal tag over the window of time.

In another aspect, the invention provides a system for monitoring animal activity, the system comprising:
an animal tag having a tag identifier, the animal tag attached to an animal to generate animal data packets comprising timestamped location data having tag latitudinal and longitudinal coordinates, and timestamped activity data relating to activity of the animal over a window of time;
a processor configured to evaluate the animal data packets to determine an activity classification for the animal wearing the animal tag over the window of time and calculate a pasture performance value of an area associated with animal based on the animal data packets received from the animal tag.

In another aspect, the invention provides an animal tag attachable to an animal for monitoring and classifying animal activity, the animal tag having a tag identifier and a processor configured to:
generate animal data packets comprising timestamped location data having tag latitudinal and longitudinal coordinates and timestamped activity data relating to activity of the animal over a window of time; and
evaluate the animal data packets to determine an activity classification for the animal wearing the animal tag over the window of time.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a system for monitoring animal activity according to an embodiment of the present invention.

FIG. 2 illustrates an animal tag for attaching to an animal and generating animal data.

FIG. 3 illustrates a graphical representation of a paddock overlaid with cows based on animal data received from respective animal tags.

FIG. 4 illustrates transmission of packets of data across multiple windows of time.

FIG. 5 illustrates sub-windows of time across the total window of time and the intervals between data packet transmissions.

FIG. 6 illustrates the activity of a cow over a second (1 second), the mean of the activity of that cow and the standard deviation.

FIG. 7 illustrates the activity of a cow over a window of time plotted on a line.

FIG. 8 illustrates the activity data shown in FIG. 7 with a normal distribution curve.

FIG. 9 illustrates the activity data shown in FIG. 8 where the data has been categorised into one of seven activity bins.

FIG. 10 illustrates a graphical representation of the activity of a herd of cows over 10 days.

FIG. 11 illustrates a graphical representation of a paddock overlaid with cows based on animal data received from respective animal tags, where a number of cows are associated with alert data packets issued from their respective animal tags.

FIG. 12 illustrates a graphical representation of a paddock overlaid with two cows showing the movement of each cow across a window of time.

FIG. 13 illustrates a graphical representation of a paddock overlaid with cows based on animal data received from respective animal tags, where the paddock is divided into four subsections and pasture performance values are assigned to each subsection based on animal data received from the animal tags.

### DETAILED DESCRIPTION OF PREFERRED EMBODIMENTS

The term “pasture performance” as used herein refers to the effect of the pasture exhibited on livestock (such as cattle) in relation to the livestock's growth and how quickly the pasture recovers from adverse conditions and events (such as, prolonged dry weather, significant or prolonged downpours, and fire, for example).

The term “activity” as used herein refers to the level of physical activity and/or temperature exhibited by an animal or livestock being monitored with an animal tag.

The Inventors have found that if a pasture has high or favourable performance, the overall distance travelled by an animal in a day will be lower than an animal located in a lower performing pasture).

The Inventors have also found that if an animal or animals roam around the entirety of a paddock, then the pasture performance is high. Conversely, if a specific part of the paddock is avoided by the animal or animals, pasture performance of that specific part of the paddock is low and may need to be improved.

Embodiments of the invention described herein relate to the tracking and monitoring of movement of animals and livestock (such as cattle) to determine activity classifications of the animals and livestock. The activity classifications have been found to be useful for identifying anomalous behaviour, which may indicate unwell animals, dropped tags and monitoring and evaluating pasture performance of a pasture that livestock is currently using to graze.

In some embodiments of the invention, the above movement of animals is combined with data relating to the paddock or area the animal or livestock is currently located in to provide further insights on the state of the animal and/or the pasture performance.

In some additional embodiments, the abovementioned monitoring and tracking is used to graphically represent and monitor individual animals or livestock, or groups of animals (such as herds of cattle) remotely by overlaying the data on an image of the area or paddock.

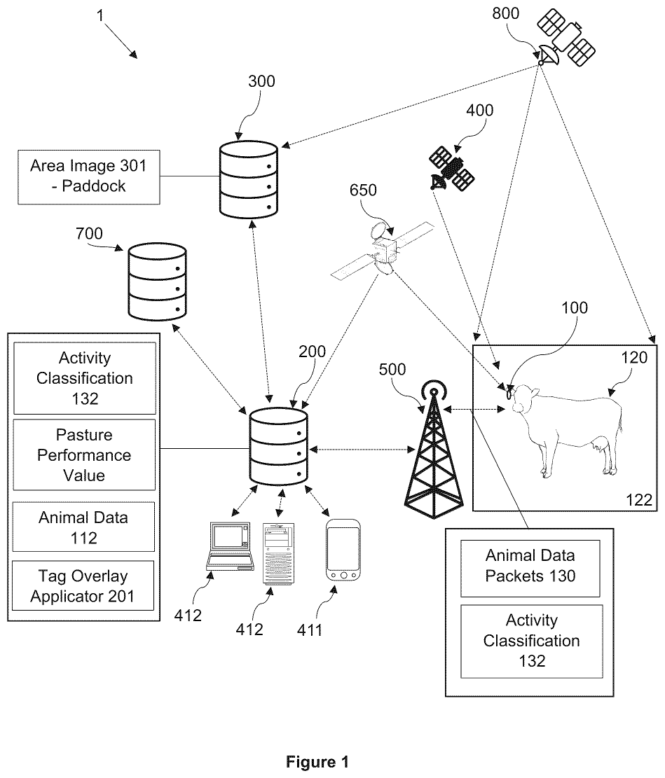

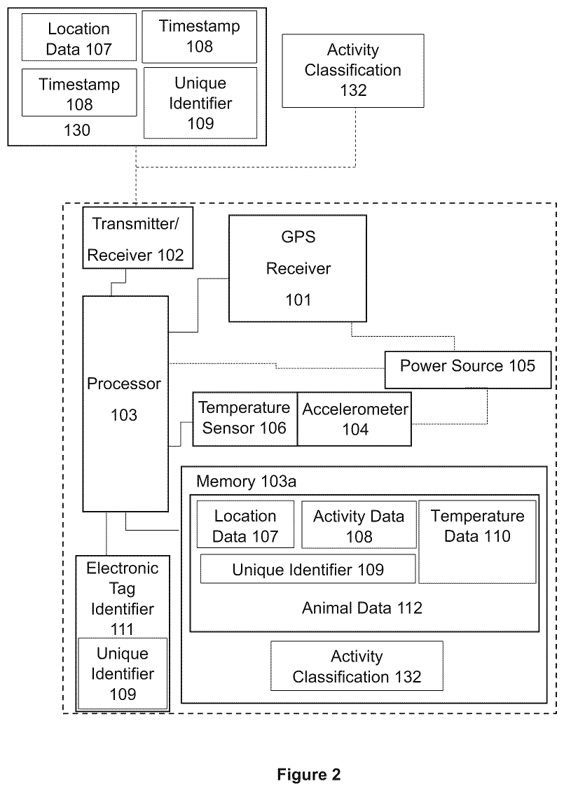

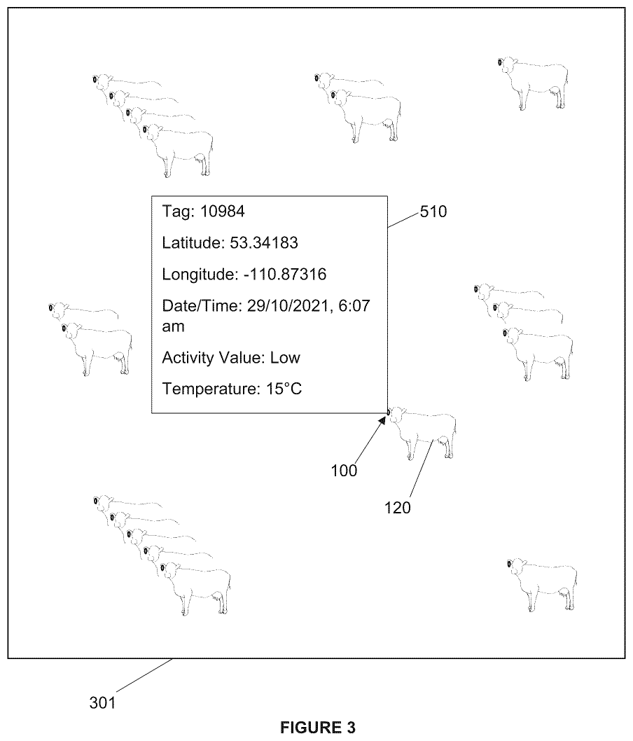

Turning now to FIGS. 1 and 2, there is illustrated a system 1 for monitoring livestock in an area. The system 1 comprises an animal tag 100 attached to an animal (in this case, a cow 120) which provides animal data packets 130 to a processing database 200 for processing and evaluation.

The animal tag 10 includes an electronic tag identifier 111 for uniquely identifying the animal tag 100 and animal 120 wearing the animal tag 100, a first sensor for determining timestamped location data 107 including the location of the animal and generating latitudinal and longitudinal coordinates associated with the animal's location and a second sensor for determining timestamped activity data 108 of the animal associated with the animal's activity. A third sensor can also be used to determine the temperature of the animal and/or the animal tag 100 and generate temperature data 110.

The animal tag 10 also includes a processor 103 configured to evaluate the animal data packets 130 to determine an activity classification 132 for the animal 120 wearing the animal tag 100 over the window of time.

The electronic tag identifier 111, in a preferable embodiment, is a radio frequency identification (RFID) module programmed to generate a unique identifier 109 (such as a serial number or identification number) which is unique to the animal tag 100 and animal 120 wearing the animal tag 100.

The first sensor may take the form of a GPS receiver 101 which is in communication with a number of GPS satellites in order to determine the location of the animal.

The second sensor may take the form of a 3-axis accelerometer 104 which allows the general movement in all directions and activity of the animal to be reliably and accurately monitored and classified. In the preferred embodiment, the accelerometer 104 functions as a three-dimensional digital linear acceleration sensor and a three-dimensional digital magnetic sensor.

In some embodiments, the accelerometer 104 is configured to constantly record movement data and the processor 103 allocates or arranges the movement data into 5 second packets. In some embodiments, the accelerometer 104 is configured to constantly record movement data and the processor 103 allocates the movement data into n second packets, where n is set or defined by the system or by a user.

The third sensor takes the form of a temperature sensor 106 for measuring and communicating the temperature of the animal. Other sensors, such as heart rate monitors, for example, could be used to monitor multiple physiological attributes of the animal.

The animal tag 100 generates the animal data 112 (i.e. timestamped location data 107 and activity data 108 of the animal) over a window of time. In particular, the animal tag 100 collects, summarises, and transmits animal data 112 at regular intervals about location, location accuracy, device temperature, activity level and the point in time at which this data was collected. The animal tag 100 can be seen to include an RF transmitter/receiver 102 for communicating the animal data 112 to remote databases and devices for storage and/or further computational evaluation and processing.

The animal tag 100 also includes a power source 105 that provides electrical power to the various components of the animal tag 100. The power source 105 preferably takes the form of a rechargeable battery that can be recharged via a solar array located on the animal tag 100. However, the power source 105 may also take the form of a removable battery or any other suitable power source.

The animal tag 100, in a preferable embodiment, only collects empirically measurable data (such as activity and location, for example) to avoid human error being introduced.

In use, the animal tag 100 transmits an animal data packet 130 including the timestamped location data 107 determined from the GPS receiver 101 through communication with GPS satellites 400, along with animal identification information (i.e. unique identifier 109). The animal data packet 130 also includes the timestamped activity data 108 determined from the accelerometer 104 and, in some embodiments, the temperature sensor 106.

In some embodiments, the animal tag 100 generates animal data 112 multiple times over the window of time and stores the animal data 112 until the collection interval is complete and the accumulated animal data 122 is transmitted. In some particular embodiments, the animal tag generates the animal data 112 at predetermined intervals over the window of time (e.g. every 10 milliseconds).

The processor 103 then receives the animal data 112 in the form of the animal data packets 130 and evaluates the animal data packets 130 to determine an activity classification 132 for the animal 120 wearing the animal tag 100 over the window of time and/or a pasture performance value of the area or paddock derived from the activity classification 132. The processor 103 may apply a trained machine learning model to the animal data 112 which will be described in more detail below.

In some embodiments, the processor 103 executes a behaviour classification algorithm that identifies and classifies specific livestock behaviours to generate behavioural data from the animal data packets. The behaviour classification algorithm is trained against raw accelerometer data and observational data to identify the specific livestock behaviours by linking a pattern of movements derived from accelerometer data from accelerometer 104 to a specific behaviour, such as walking, resting, grazing, ruinating, drinking and unclassified/other, for example.

It will be appreciated that the processor 103 may be located in the animal tag itself wherein the animal data packets are provided to a processor 103 from memory 103a within the animal tag 100 and the processor 103 is programmed to calculate the activity classification 132 and pasture performance value which is then transmitted to a remote database (such as processing database 200, for example) which processes the data and graphically represents the data on a display providing a graphical user interface (such as computer 412 or smartphone 411, for example).

In one embodiment, every 5 seconds, the processor 103 of the animal tag 100, using the behaviour classification algorithm, assesses the latest 5 second packet (or n second packet) of movement data collected by the accelerometer 104 and compares the movement data against the trained behaviours and identifies the dominant, or most likely, behaviour undertaken during that 5 second window in the packet of movement data to generate behavioural data.

This behavioural data can be used at a raw level (what was the animal doing at a specific time), which can be accessed via Bluetooth communications or summarised (e.g., hourly, or daily behaviour summaries), which can be accessed via Bluetooth or direct-to-satellite communications (as described in more detail elsewhere).

In some other embodiments, the processor may be located remotely from the animal tag 100 (at processing database 200, for example) and the processor receives the animal data 112 from each animal tag 100 and the processor is programmed to calculate the activity classification 132 and pasture performance value which can then be graphically represented on a graphical user interface on a display.

Communication between the processing database 200 and the animal tag 100 may be facilitated through a number of known means. For example, the smart tag 100 and processing database 200 may be configured to communicate via satellites, such as low earth orbiting satellites 650 or medium earth orbiting satellites (not shown), or through a mobile communication base station 500, such as a cellular communication tower or Low Power Wide Area Network (LPWAN) base station or Bluetooth.

The pasture performance value provides an indicator of the current state of the pasture or paddock. For example, a low pasture performance value for a section of the pasture may indicate undesirable biomass or a lack of available biomass. In another example, a declining pasture performance value for a section of the pasture may indicate a decline in available biomass in that subsection and therefore the livestock should be moved to another section of the pasture with greater available biomass.

In determining the activity classification 132, the processor 103 may determine a single activity classification 132 for the window of time or a plurality of activity classifications 132 for the animal wearing the animal tag 100.

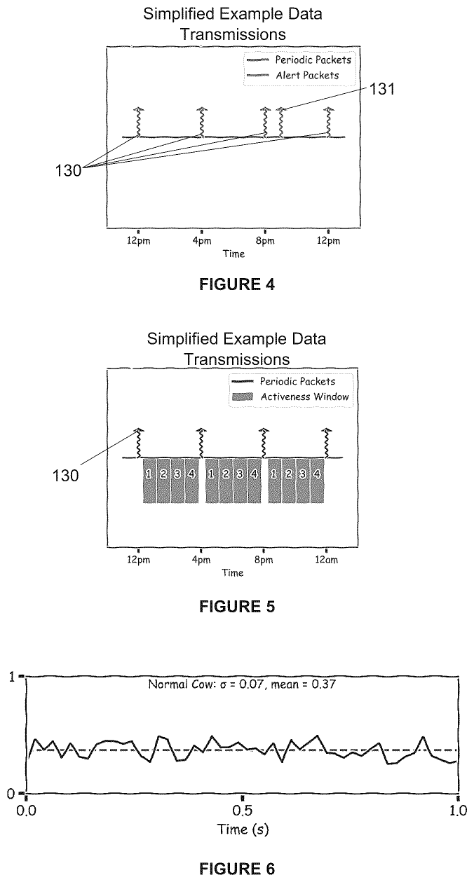

In instances of a plurality of activity classifications 132, each activity classification 132 is associated with a sub-window of the window of time. As an example, which is illustrated in FIG. 4, the window of time is divided into a plurality of sub-windows and each sub-window comprises the same amount of time (e.g. the window of time is 4 hours and is divided into 4 sub-periods, each 1 hour long) and an activity classification 132 is determined for each hour long sub-period.

In a further embodiment of the invention, the system 1 comprises an image of an area 301 comprising one or more paddocks having area latitudinal and longitudinal coordinates. The image 301 may be obtained directly from an imaging satellite 800 or a public or private database 300 storing said images. In the embodiment, the processor (not shown) at processing database 200 is configured to apply a tag overlay applicator 201 so that each animal tag 100 is graphically represented on the image of the area 301 at the corresponding latitudinal and longitudinal coordinates received from the animal data 112. This allows users of the graphical user interface to accurately and reliably view the location of each animal without needing to physically visit or observe the animal in the paddock.

The processor, using the animal data 112, then allocates a label comprising the tag identifier, the location data, and activity data relating to the animal to each graphically represented animal tag. This, usefully, allows each animal and respective animal tag 100 to be monitored and reported on both remotely and graphically. An example of this embodiment can be seen FIG. 5.

Effectively, the system 1 visualises the geolocation of a plurality of animal tags 100, each attached to a cow 120, on the image of the area 301 and provides an end user with both current and historical data from each animal tag 100 in the form of a popup window 510. While the cows 120 are shown individually in the illustrated embodiments, in some embodiments, multiple cows can be grouped (in herds, for example) to observe, monitor and evaluate herd behaviour. In some additional embodiments, the location and/or activity of individual animals or groups of animals across a window of time may be graphically represented in the form of a heatmap where a short time spent in a location or low activity in a location over the window of time is represented by a small blue circle (or polygon) surrounding the animal, for example, and a long time spent in a location or high activity in a location over the window of time is represented by a large red circle (or polygon) surrounding the animal.

The animal data 112 can then be combined with other data, such as Cadastral data, Lidar data, weather data, water data, topographical data, land parcel data (ingested and user generated), pasture intake values or data, individual animal user generated data, soil moisture, biomass readings, vegetation indices and species lists, for example, obtained from a database 700.

This data is obtained through publicly available datasets (such as, Bureau of Meteorology, Amazon Web Services, Google Cloud, Geoscience Australia, for example) or through private datasets.

The processor 103 may determine the activity classification 132 and/or the pasture performance value by evaluating the animal data packets 130 to determine an activity classification 132 for the animal 120 wearing the animal tag 100 over the window of time by evaluating the animal data packets 130 with a trained machine learning model to determine the activity classification 132 and/or the pasture performance value.

The initial training set provided to build the trained machine learning model includes the “Natural Capital” of a specific parcel of land, both current and historical, as a base and then incorporates the amount of interest or surplus food is available to be consumed by animals on a given parcel of land, the number of animals this available food provides for and for how long.

Turning now to measuring and evaluating activity of the animal, as described above, the animal tag 100 transmits animal data 112 in periodic packets (i.e. the animal data packets 130). In the illustration shown in FIGS. 4 and 5, the periodic packet is sent every 4 hours (i.e. the window of time). Special alert packets can also be sent outside of the typical time period and this will be described in more detail below.

A measure of activeness for the previous four hours is sent back with every periodic packet. The four hour period is divided up into four one hour sections. Next, the standard deviation of the accelerometer readings for each one hour sub-period or section is calculated as seen in FIG. 6.

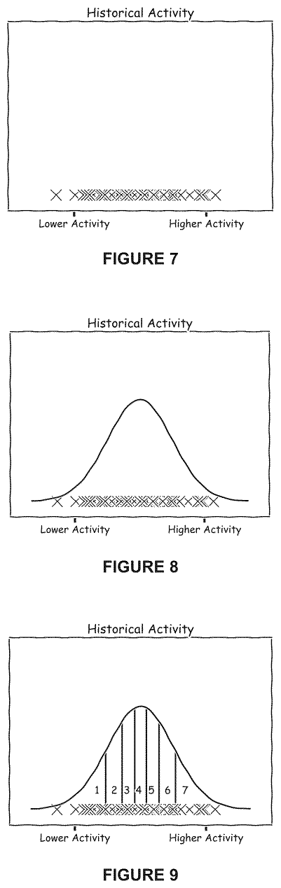

The activity of the animal 120 is plotted (See FIGS. 7 and 8 showing the activity distribution and the normal distribution of the activity). Turning to FIG. 9, an activity value between one and seven is saved for each hour window through comparison with historical values. A zero value is generated if there is an error. For normally distributed data, almost all (approximately 99.7%) of all observed data will fall within three standard deviations of the mean (represented by activity value 4 in FIG. 9) and therefore activity classifications 3 and 5 relate to a first standard deviation from the mean; activity values 2 and 6 relate to a second standard deviation from the mean; and activity values 1 and 7 relates to a third standard deviation from the mean. Thus, the activity values for animals, both individually and relatively, are determined relative to a defined average activity classification or level.

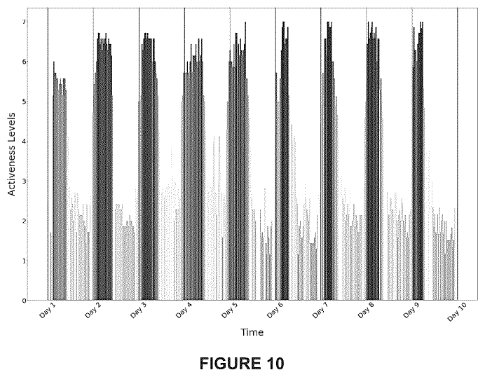

This calculation then provides an activity classification 132 for each animal 120 over a window of time. An example of how this data can be visually represented across an entire herd is shown in FIG. 10.

Advantageously, this provides insights and monitoring for herd activity and allows for the comparison and analysis of relative activity between herds.

The embodiments and examples described herein is primarily directed to cattle but may be applied to other pasture grazing animals where appropriate.

Furthermore, this activity monitoring allows variations across individual days, months and years to be observed, monitored and analysed.

As mentioned above, in some embodiments, either alternatively or in addition to the above, the animal tag 100 collects and transmits animal data at a point in time when a predefined threshold relating to the activity of the animal is met. When this threshold is reached, location data and threshold data are collected and transmitted as alert data packets.

These alert data packets 131 (see FIG. 4) are sent outside of the defined periodic data reporting cycle where the alert packet is sent immediately and provides information relating to the specific alert trigger. It should be appreciated that alert data packets 131 can be sent at any time and their transmission is triggered by a threshold value or criteria being met rather than a specific time since the previous transmission elapsing.

One specific example of an alert packet being generated lies in the detection of high activity or anomalous activity from the animal.

To determine anomalous, high levels of activity, the processor 103 of the animal tag 10 checks the previous 10 minutes of activity data. It should be noted that the activity is measured with a modified mean.

If the mean of the previous 10 minute period is larger or greater than 9 times the average value over the last 6 days, an alert packet is immediately generated and transmitted. If this high or unusual activity continues, an alert data packet will continue to transmit every hour. However, the alert data packet will stop automatically after 6 hours even if the anomalous behaviour continues.

In another example, an alert packet is generated when it is determined that the animal tag has fallen off the animal. Detecting this occurrence quickly can be incredibly difficult, as some animals (such as cows) can be very still for long periods of time.

The Inventors have found that by averaging the activity of an animal over a 60 minute period, the average activity is unlikely to intersect with the average activity of an animal tag that has become detached from an animal. Thus, an alert data packet is generated if no activity has been observed on the animal tag for a period of 60 minutes. Once triggered, the alert data packet will continue to send alerts every 12 hours unless movement is detected.

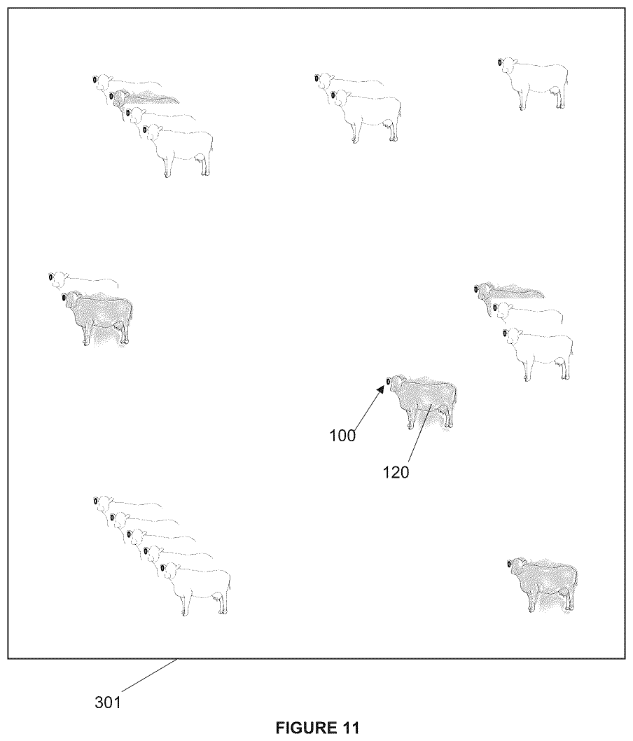

Turning to FIG. 11, an example of an updated graphical user interface showing cows 120 associated with an alert data packet 131 on the image of the area 301 is shown. In the illustrated example, any cow 120 associated with an alert data packet is shown with a shading compared to the other cows 120 not associated with an alert data packet.

In some further embodiments, the animal tag also collects and transmits daily pasture feed intake of the livestock wearing the animal tag.

In some embodiments, the animal tag 100 is configured to generate pasture intake data including an estimate of pasture (or dry matter) intake from the behavioural data (and in particular, grazing data) for the animal associated with the animal tag 100.

Alternatively, the processing database 200 receives the behavioural data from the animal tag 100 and is configured to apply a calculation to the behavioural data to estimate pasture intake for the animal associated with that animal tag 100 and generate pasture intake data.

In either of the above embodiments, the pasture intake data may then be used to generate methane production data including estimates of methane production for the animal associated with the animal tag 100 using a calculation applied to the pasture intake data.

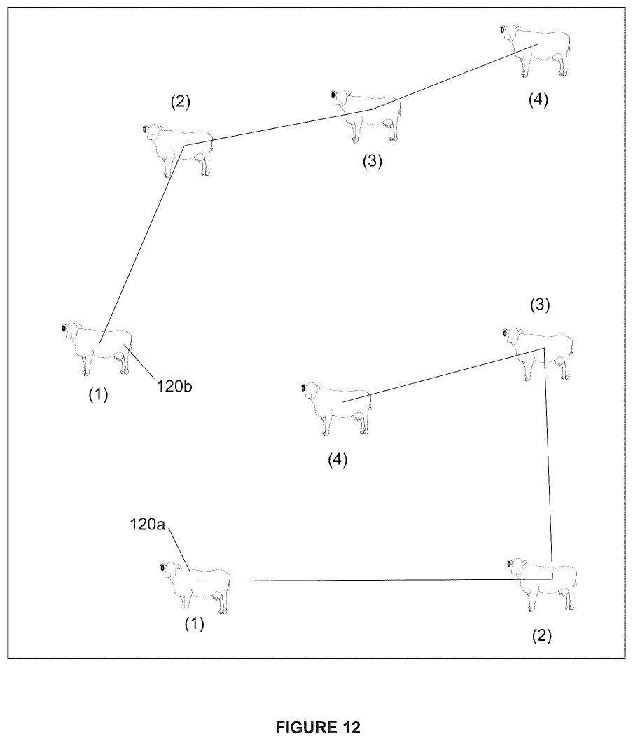

Embodiments of the invention provide for real time and historical monitoring of a pasture or paddock to evaluate pasture performance and guide future livestock allocation to the pasture. For example, with reference to FIG. 12, the movement of two cows 120a, 120b over the window of time (i.e. 4 hours) is tracked and graphically represented on the display, whereby the cows 120a, 120b position in the physical world is accurately represented on the corresponding image of the area 301 that the cows 120a, 120b currently inhabit.

As noted above, the pasture performance value provides an indicator of the current state of the pasture or paddock, or sections of the paddock. Pasture performance evaluation can be improved by dividing a paddock or area into subsections and assessing evaluating those individual subsections. Subsections can be implemented using geofence boundaries which the Inventors envision is useful in improving pasture performance analysis and evaluation.

Embodiments of the invention can be used to assist with decision making through behaviours identified through the behavioural data. For example, if the average time spent walking has increased materially it may be time to move the cattle as they are spending too much time walking for pasture.

Embodiments of the invention can also be used to assist with problem detection through behaviours identified through the behavioural data. For example, if an animal's resting time has increased markedly while walking and grazing times have decreased, this may indicate that the animal needs to be checked.

Embodiments of the invention can also provide demonstrable proof of improved land management practices by showing improved animal grazing and methane output data.

Embodiments of the invention provide recorded proof of animal location. Combined with grazing metrics, the invention can demonstrate if an animal was or was not in a designated deforestation area, for example.

Embodiments of the invention can also improve genetic selection. The activity classification (and in particular, the behavioural data) may help in identifying which animals are most efficiently converting pasture to protein to improve genetic selection decisions. For example, through measuring pasture intake, a comparison between pasture intake and weight gain of individual animals can provide insights into specific animals that gain more weight from less pasture which are therefore utilising fewer resources and producing less methane. Thus, it may be favourable to selectively use that animal, or animals with similar characteristics, for breeding.

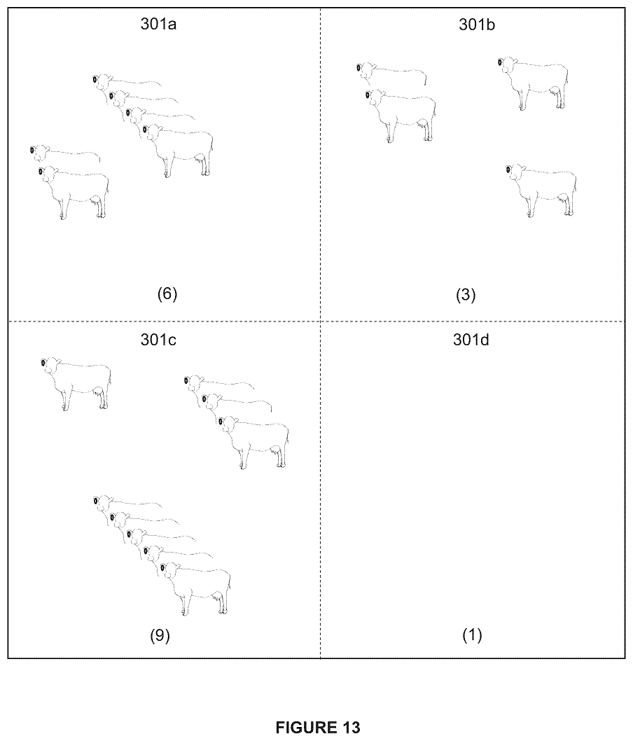

Referring to FIG. 13, there is a paddock represented by image 301 divided into four subsections 301a-d using geofence boundaries. The plurality of cows 120, each having an animal tag 100 generating animal data in accordance with the description above, are monitoring over a window of time and associated activity classifications and pasture performance levels are determined. Paddock subsection 301a has a relatively high number of cows 120 that are not moving from that subsection and is determined to have reasonable amounts of available biomass and is therefore evaluated to have a pasture performance level of 6. Paddock subsection 301ba has a relatively low number of cows 120 that is gradually decreasing and is determined to have declining amounts of available biomass and is therefore evaluated to have a pasture performance level of 3, indicating that pasture performance may need to be improved, either by revitalisation or by moving the cows 120 in subsection 301b to a different area. Paddock subsection 301c has a relatively high number of cows 120 that are not moving from that subsection and is determined to have very high amounts of available biomass and is therefore evaluated to have a pasture performance level of 9. Finally, paddock subsection 301d has no cows and is determined to have low amounts of available biomass and is therefore evaluated to have a pasture performance level of 1, indicating that urgent attention is needed to this pasture or that the pasture is unsuitable for use.

In some embodiments, a filter, such as a multispectral filter, may be applied to the image 301 to reveal addition information and provide enhanced insights.

While various embodiments and examples herein have been described with specific reference to a cow or multiple cows, embodiments of the invention can be readily applied to and used with other animals, such as other ruminant animals and various wildlife.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A system for monitoring animal activity, the system comprising:
an animal tag having a tag identifier, the animal tag attached to an animal to generate animal data packets comprising timestamped location data having tag latitudinal and longitudinal coordinates, and timestamped activity data relating to activity of the animal over a window of time; and
a processor configured to evaluate the animal data packets to determine an activity classification for the animal wearing the animal tag over the window of time.

2. The system according to claim 1, wherein the animal tag comprises an accelerometer.

3. The system according to claim 2, wherein the animal tag includes the processor and memory to store animal data and the animal data packets.

4. The system according to claim 3, wherein the accelerometer is configured to constantly record movement data and the processor arranges the movement data into n second packets.

5. The system according to claim 1, wherein the activity classification includes behavioral data indicative of a behavior of the animal at one or more points in time during the window of time or across the entire window of time.

6. The system according to claim 5, wherein the behavioral data indicative of the behavior of the animal at one or more points in time during the window of time or across the entire window of time is classified as one of: Walking; Resting; Grazing; Ruminating; Drinking; and Other (Unclassified).

7. The system according to claim 5, wherein the activity classification further comprises pasture intake data, wherein the processor evaluates the animal data packets to determine the activity classification including the pasture intake data including an estimate of pasture intake determined based on the behavioral data for the animal associated with the animal tag.

8. The system according to claim 6, wherein the estimate of pasture intake is determined based on behavioral data classified as Grazing.

9. The system according to claim 1, wherein the animal tag generates timestamped location data having tag latitudinal and longitudinal coordinates and timestamped activity data relating to activity of the animal multiple times over the window of time.

10. The system according to claim 1, wherein the animal tag generates timestamped location data having tag latitudinal and longitudinal coordinates and timestamped activity data relating to activity of the animal at predetermined intervals over the window of time.

11. The system according to claim 1, wherein evaluating the animal data packets to determine the activity classification for the animal wearing the animal tag over the window of time comprises determining a plurality of activity classifications for the animal wearing the animal tag, wherein each activity classification is associated with a sub-period of the window of time.

12. The system according to claim 2, wherein the timestamped activity data relating to activity of the animal over a window of time comprises a temperature of the animal and/or the animal tag and the movement data relating to the movement of the animal.

13. The system according to claim 1, wherein the processor is further configured to calculate a pasture performance value of a paddock or an area associated with the animal based on the animal data packets and activity classification received from the animal tag and/or geofence data associated with the animal tag, wherein the paddock or the area associated with the animal is derived from the location data received from the animal tag, wherein calculating the pasture performance value based on the animal data packets received from the animal tag comprises evaluating the animal data packets for each timestamp to determine the activity classification for the animal wearing the animal tag.

14. The system according to claim 7, wherein the processor is further configured to evaluate the pasture intake data to determine methane production data including estimates of methane production for the animal associated with the animal tag.

15. The system according to claim 1, wherein, the system comprises a plurality of animal tags, each animal tag being attached to a unique animal to generate timestamped animal data packets comprising location data having tag latitudinal and longitudinal coordinates and activity data relating to activity of the animal.

16. The system according to claim 1, wherein the system further comprises applying a trained machine learning model to animal data packets and evaluating the animal data packets to determine the activity classification for the animal wearing the animal tag over the window of time comprises evaluating the animal data packets with a trained machine learning model to determine the activity classification and/or the pasture performance value.

17. The system according to claim 1, wherein the processor of the system for monitoring livestock in an area is further configured to generate an alert when the activity classification exceeds a threshold value or is outside of a threshold range.

18. The system according to claim 1, wherein the system further comprises an image of an area comprising one or more paddocks having area latitudinal and longitudinal coordinates and the processor is further configured to:
apply a tag overlay applicator so that each tag is graphically represented on the image of the area on a display at the corresponding latitudinal and longitudinal coordinates received from the animal data packets; and
allocate to each graphically represented tag:
a label comprising the tag identifier;
the location data; and
activity data relating to the animal.

19. A method for monitoring animal activity comprising:
evaluating animal data comprising a tag identifier for an animal tag attached to an animal to generate animal data packets comprising timestamped location data having tag latitudinal and longitudinal coordinates and timestamped activity data relating to activity of the animal over a window of time; and
determining an activity classification for the animal wearing the animal tag over the window of time.

20. An animal tag attachable to an animal for monitoring and classifying animal activity, the animal tag having a tag identifier and a processor configured to:
generate animal data packets comprising timestamped location data having tag latitudinal and longitudinal coordinates and timestamped activity data relating to activity of the animal over a window of time; and
evaluate the animal data packets to determine an activity classification for the animal wearing the animal tag over the window of time.
